(19) United States
(12) Patent Application Publication
(10) Pub. No.: US 2011/0311799 A1
(43) Pub. Date: Dec. 22, 2011

(54) Insulating Panel Made From Reclaimed Foam

(76) Inventor: Fred Jevaney, Elmhurst, IL (US)

(21) Appl. No.: 12/819,889

(22) Filed: Jun. 21, 2010

(51) Int. Cl. B32B 3/26; B32B 37/14

(52) U.S. Cl. 428/304.4; 156/94

(57) ABSTRACT

An insulating panel and a method of manufacturing the same are disclosed are disclosed. The insulating panel is manufactured, at least in part, through the use of reclaimed materials.

### FIELD OF THE INVENTION

The present embodiments relate to insulating panels composed, at least in part, of reclaimed materials.

### BACKGROUND

Insulating panels, such as bulkheads, are used in trailers and the like to divide the trailer into separate storage compartments and, sometimes, to maintain each compartment at a temperature necessary to preserve the goods during transport. Frequently, the bulkheads are movable to allow a user to adjust the size or configuration of the individual compartments.

Movable bulkheads must be sufficiently strong to withstand the rigors of routine daily use, shifting loads during transit and potentially damaging lifts and trolleys that are used to load and unload products from the trailer. The movable bulkheads should also be sufficiently light so that the user may adjust or reposition them with relative ease.

Traditionally, insulating panels have been made using new (previously unused) materials, such as open and closed cell foams, including petrochemically-derived materials.

### BRIEF SUMMARY

Insulating panels made from reclaimed materials, and methods of making the same, are presented. The insulating panels may include any of the following aspects in various combinations and may also include any other aspect described below in the written description or shown in the attached drawings.

### BRIEF DESCRIPTION OF THE DRAWINGS

FIG. 1 is a front elevational view of one embodiment of a reinforced bulkhead.

FIG. 2 is a horizontal cross-section view of one embodiment of a reinforced bulkhead taken across line 2-2 shown in FIG. 1.

FIG. 3 shows an exploded view of the pre-assembled layers of one embodiment of a reinforced bulkhead.

### DETAILED DESCRIPTION OF THE DRAWINGS

The insulating panels of the present embodiments are moveable bulkheads for use in trailers and the like. A person skilled in the art will understand that the following teachings with regard to the bulkhead embodiments are also applicable to other insulating panels, such as insulating curtains and the like.

FIG. one shows one embodiment of a bulkhead 1. The bulkhead 1 has front and back sides and four edges. The bulkhead has a vertical length and a horizontal width. The bulkhead 1 includes bumpers 5 around the periphery of the bulkhead. The bumpers 5 provide a resilient and deformable seal between the edge of the bulkhead and the structure adjoining the bulkhead, such as the floor, ceiling, walls or another bulkhead. The bulkhead 1 also includes a kick plate 6. Kick plate 6 is a rugged plate that protects the bulkhead 1 from damage in the course of ordinary use, such as damage caused by carts or trolleys when loading and unloading goods from the trailer. In one embodiment, the kick plate 6 is made of an ultra high molecular weight polyethylene. The kick plate may be attached to the bulkhead 1 using any known fastening system, including screws, rivets or adhesive.

The bulkhead 1 may also include straps 13. The straps 13 provide a handhold for raising or lowering the bulkhead between the closed (vertical) position and the open (horizontal) position. The straps 13 may be attached to the bulkhead using any acceptable means of attachment, such as a bolt through the strap and bulkhead that is secured with a nut. Further, the bulkhead may include tie straps (not shown) that have clips at each end. The tie straps may be used to help secure the bulkheads in place by attaching the clips to sockets located in tracks in the walls of the trailer. The tie straps may be attached to the bulkheads using well known fasteners, such as eyes, bolts, rivets and buckles.

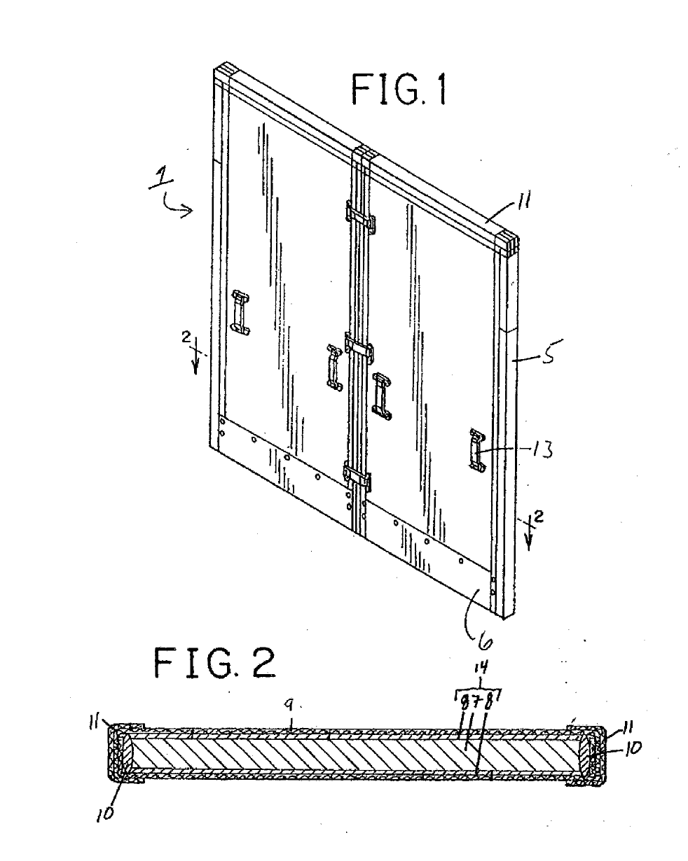

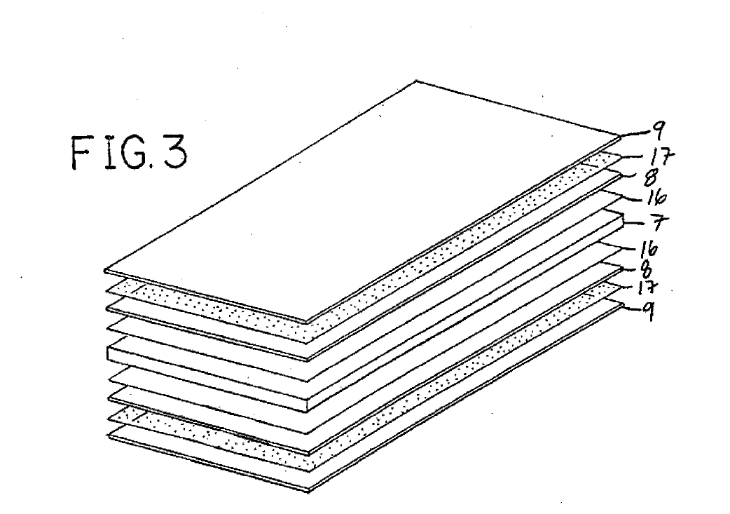

FIG. 2 shows a cross-section of the finished bulkhead of FIG. 1 and shows the construction of the bulkhead 1 in greater detail. FIG. 3 shows an exploded view of the pre-assembled layers of one embodiment of a bulkhead. The bulkhead 1 includes a bulkhead core 14. The bulkhead core 14 includes a central layer 7 and outer layers 8. While a three layer core is shown in FIG. 2, any number of layers may be used in the present embodiments. In one embodiment, the bulkhead core is approximately 48 inches wide, 108 inches long, and 3 inches thick.

Materials that are suitable for the layers of the bulkhead core are well known in the art. Any such material is acceptable for use in the present embodiments. For bulkheads that may be used to divide refrigerated compartments, it is desirable that the material for the bulkhead core have good insulating properties so that the finished bulkhead provides an effective thermal barrier between compartments. By way of example, materials used for the bulkhead core include closed or open cell foams that are made from a polymeric material such as polystyrene, polyurethane, polyethylene, polypropylene, polyisocyanurate or expandable rubber. However, those skilled in the art understand that other materials may also be used.

In one embodiment, the central layer 7 is made of a reclaimed closed cell foam made of expandable polystyrene, and the central layer 7 has a thickness of approximately two and one-half inches. The central layer 7 may also be rigid (i.e., the material is self-supporting and does not collapse under its own weight). The central layer 7 is described in greater detail below.

In another embodiment, the outer layers 8 are made from a different material than the central layer 7 and are thinner than the center layer 7. The outer layers may also have a hardness that is lower than the hardness of the central layer 7. In one embodiment, the outer layers 8 are made of a polyethylene foam.

The outer layers 8 may be attached to the center layer 7 with a sheet of hot melt adhesive 16, as shown in FIG. 3. Such hot melt adhesives are well known in the art. An exemplary hot melt adhesive is commercially available from BOSTIK under the tradename 2571B.

The bulkhead 1 shown in FIGS. 1 and 2 also includes a protective skin 9. Like the bulkhead core, materials for the protective skin 9 are well known in the art, and any one of the materials known in the art is acceptable for use in the present embodiments, including acrylonitrile butadiene styrene, reinforced vinyl, a composite mesh of fiberglass and polyethylene or polypropylene and woven polyethylene. The protective skin 9 may be a woven polymeric material. In one embodiment, the protective skin 9 is made of 18 ounce vinyl.

The protective skin 9 may be attached to the bulkhead core 14 using any acceptable means of attachment, including adhesive or hot melt technology. The protective skin 9 and the outer layers 8 may be made of the same or similar material (e.g., both are polyethylene or both are vinyl), and may be bonded together using hot melt technology. Alternatively, film adhesive polyethylene 17 may be used, as shown in FIG. 3. In one embodiment, the film adhesive is a 2 mil film that is commercially available from DOW CHEMICAL under the tradename INTEGRAL 801.

The bulkhead 1 shown in FIGS. 1 and 2 also includes bumpers 5. The bumpers 5 provide a resilient, deformable seal between the bulkhead and the walls, floor, ceiling and/or adjacent bulkheads. Bumper constructions are well known in the art, and any one of the constructions is acceptable for use in the present embodiments. In the embodiment shown in FIG. 2, the bumper 5 includes bumper material 10 that may be made of any acceptable material, such as a synthetic, loose-fill material such as flexible polyethylene or urethane foam. The bumper material 10 may be attached to the edge of the bulkhead core with pressure sensitive glue.

The bulkhead 1 shown in FIGS. 1 and 2 also include a protective wrap 11. The protective wrap 11 is applied to the edges of the bulkhead 1 and protects the bulkhead 1 from abrasive wear and tear during the ordinary use of the bulkhead 1. The protective wrap may consist of a durable, wear-resistant material, such as vinyl, polyethylene and nylon. The protective wrap may be heat sealed to the bulkhead but alternatively, may be attached with an adhesive or any other suitable attachment system. If the protective wrap 11 is to be heat sealed to the bulkhead, the protective wrap 11 and the skin 9 may be made of the same or similar material (e.g., both are polyethylene or both are vinyl).

As noted above, the materials used for one or more of the layers may include polystyrene, polyurethane, polyethylene, polypropylene, polyisocyanurate or expandable rubber. Many of these materials have traditionally been used in other industries. For example, many buildings are lined with polyisocyanurate (similar to polyurethane materials) or extruded or expanded polystyrene foam insulation. Because the useful lives of these materials often exceed the lifespan of the structures in which they are originally installed, large quantities of these, and other similar materials, end up being disposed of, often in landfills. As these insulated structures are demolished, the polyisocyanurate, extruded or expanded polystyrene foam insulation, and other similar materials, may be recovered or reclaimed for reuse. Similarly, these materials may be reclaimed from other industrial uses so that the materials are not disposed of in landfills or incinerators.

These reclaimed materials may be used as one or more of the layers in the insulating panels of the present embodiments. For example, the central layer 7 of the movable bulkheads may be manufactured using recycled materials. The reclaimed insulation, such as extruded polystyrene produced under tradenames such as PROPINK and FOAMULAR from OWENS CORNING of Toledo, Ohio and STYROFOAM from DOW CHEMICAL COMPANY of Midland, Mich., expanded polystyrene and polyisocyanurate may be recovered from structures or purchased from distributors of reclaimed materials such as INSULATION DEPOT of Framingham, Mass. While the reclaimed materials listed may be more suitable for use in the central layer 7, those skilled in the art understand that the outer layers 8, bumpers 10 and other suitable elements may also be made from reclaimed materials. Through this use of reclaimed materials, the volume of relatively non-degradable materials entering landfills or being incinerated may be reduced. Further, use of such reclaimed materials reduces the consumption of petrochemicals and other chemical constituents as well as the consumption of energy for production of these materials.

The bulkheads of the present embodiments may be used in any number of well-known bulkhead systems. Exemplary systems include, for example, the trolley and rail system shown in U.S. Pat. No. 4,639,031 or U.S. Pat. No. 2,866,419. In order to be used in such a system, the bulkhead is capable of being attached to the rail system. Accordingly, the side of the bulkhead that is attached to the rail system may have a slightly different shape with cut-outs for accommodating the mounting equipment. The bulkhead may also have equipment attached to, or integrally molded with, the bulkhead in order to attach the bulkhead to the rail system.

A method of manufacturing bulkheads in accordance with the present embodiments will now be described. The method described below relates to the bulkhead embodiments described above, however, it should be understood that the method may be adapted for use in manufacturing other bulkhead embodiments. The center layer of the bulkhead core is cut to the desired shape. The outer layers of the bulkhead core are attached to the center layer with sheets of hot melt adhesive. When using reclaimed material, the reclaimed material may be cleaned or surfaced prior to attaching the outer layers to remove dirt, oil or any other impediments to a proper attachment. Similarly, if the outer layers are also reclaimed materials, the outer layers may also be cleaned or surfaced.

The bulkhead may also be trimmed to a particular size and shape. The bulkhead may be trimmed because bulkheads do not come in a standard size and shape; rather, the size and shape of the bulkhead varies according to the particular trailer and bulkhead configuration for each customer. The bulkhead may be trimmed using any acceptable forming device such as, for example, a band saw.

The skin 9 is also applied to the front and back sides of the bulkhead core. The skin 9 may be attached using a sheet of adhesive film. Alternatively, the skin 9 may be attached to the bulkhead core by applying sufficient temperature and pressure to the skin so that the skin 9 and outer layers 8 of the bulkhead core partially melt and form a fusion bond. In one embodiment, the skin 9 that is applied to the front and back sides of the bulkhead core 14 is longer and wider than the dimensions of the bulkhead core 14 so that there is extra material that may be folded around the bumper material, as described below.

The bumper material 10 is placed around the periphery of the bulkhead core and secured to the edges of the core with pressure sensitive glue. The extra skin 9 that extends beyond the edges of the bulkhead core 14 is folded around the bumper material 10.

The protective wrap 11 is applied to the edges and wrapped around the bumper material 10. The protective wrap 11 is attached to the bulkhead using adhesive, such as a synthetic rubber adhesive, to form the finished bulkhead.

Extra features and structures, including the kick plate 6 and straps 13, may be attached to the bulkhead using bolts, screws, mechanical fasteners, adhesives or any other anchor that provides a strong connection between the structure and the bulkhead.

While the description provided herein has focused on the application of movable bulkheads in truck trailers, the bulkheads have other uses. For example, those skilled in the art understand that bulkheads similar to those described herein may be used in rail cars, or other vehicles.

Further, it should be understood that the bulkheads may be arranged in many different fashions to compartmentalize a trailer. As described above, the bulkheads may be arranged transversely to a longitudinal axis of a trailer, fitting tightly along the walls, floor and ceiling of the trailer. Alternatively, several movable bulkheads may be arranged in series to divide the trailer along the longitudinal axis into two or more compartments. Those skilled in the art understand that other arrangements are within the scope of the present embodiments.

It is intended that the foregoing detailed description be regarded as illustrative rather than limiting and that it be understood that it is the following claims, including all equivalents, that are intended to define the spirit and scope of this invention.

1. A method of manufacturing an insulating panel comprising:
reclaiming a first piece of material comprising foam material from a previous use;
cutting the first piece of material to a desired core size such that the first piece of material has two sides and four edges; and,
affixing a second material to each side of the first piece.

2. The method of claim 1, wherein the first piece of material comprises a foam material selected from the group consisting of: polyisocyanurate, extruded polystyrene or expanded polystyrene foam insulation.

3. The method of claim 1, wherein the foam material has been used one or more times as building insulation.

4. The method of claim 1 further comprising attaching a bumper material to the edges of the affixed first and second materials prior to affixing the skin material.

5. The method of claim 4 further comprising:
applying a wrapping material over the bumper material so that portions of the wrapping material overlap with the skin material, and
affixing the overlapping portions of the wrapping material to the skin material.

6. The method of claim 1 further comprising cleaning the first piece of material prior to affixing the two second pieces of material to the first piece of material.

7. The method of claim 1, wherein the first piece is a rigid material.

8. The method of claim 1, wherein the insulating panel is a bulkhead.

9. An insulating panel comprising:
a center core composed of reclaimed foam insulating material;
two pieces of an outer core foam material, one piece affixed to each side of the center core;
a bumper material attached to the edges of the center core and outer core structure; and
a skin material attached to each of the exposed sides of the outer core material.

10. The insulating panel of claim 9, wherein the reclaimed foam insulating material comprises a foam selected from the group consisting of: polyisocyanurate, extruded polystyrene or expanded polystyrene foam insulation.

11. The insulating panel of claim 9, wherein the insulating panel is a bulkhead.

12. The insulating panel of claim 9, wherein the two pieces of outer core foam material comprise reclaimed material.

13. A bulkhead comprising reclaimed foam insulating material.

14. The bulkhead of claim 13, wherein the bulkhead further comprises:
a center core;
two pieces of an outer core foam material, one piece affixed to each side of the center core;
a bumper material attached to the edges of the center core and outer core structure; and
a skin material attached to each of the exposed sides of the outer core material.

15. The bulkhead of claim 13, wherein the reclaimed foam insulating material comprises a foam selected from the group consisting of: polyisocyanurate, extruded polystyrene or expanded polystyrene foam insulation.

16. The bulkhead of claim 13, wherein the foam insulating material has been used one or more times as building insulation.

17. The bulkhead of claim 13, wherein the foam insulating material is rigid.
